(19) United States
(12) Patent Application Publication
(10) Pub. No.: US 2011/0069171 A1
(43) Pub. Date: Mar. 24, 2011

(54) METHOD AND SYSTEM FOR AUTONOMOUS VIDEO MONITORING

(75) Inventor: HUO-PING FU, Shenzhen City (CN)

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/617,965

(22) Filed: Nov. 13, 2009

(30) Foreign Application Priority Data
Sep. 23, 2009 (CN) 200910307516.X

(51) Int. Cl. H04N 7/00; G06K 9/00

(52) U.S. Cl. 348/152; 382/103; 348/E07.091

(57) ABSTRACT

A method for autonomous monitoring includes the following steps. A plurality of video signals of a region to be monitored is collected by a video signal collecting module. A current image and a previous image of the region to be monitored are analyzed by an image processing module. A number of points of difference between the current image and the previous image is calculated by an image comparison module. The image comparison module stores a predetermined threshold value of different points and is capable of outputting an alarm signal when the number of different points exceeds the predetermined threshold value. An alarm condition is indicated by an alarm module when the alarm signal is received.

### BACKGROUND

1. Technical Field

The present disclosure relates to a method and system for autonomous video area monitoring.

2. Description of Related Art

Nowadays, public areas are often monitored via video equipment that is connected to a computer in a manned monitoring center. The manning of the monitoring center is expensive

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric view of a system for autonomous video monitoring, in accordance with an embodiment.

FIG. 2 is a block diagram of the system of FIG. 1.

FIG. 3 is a flow chart of a method for autonomous video monitoring.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

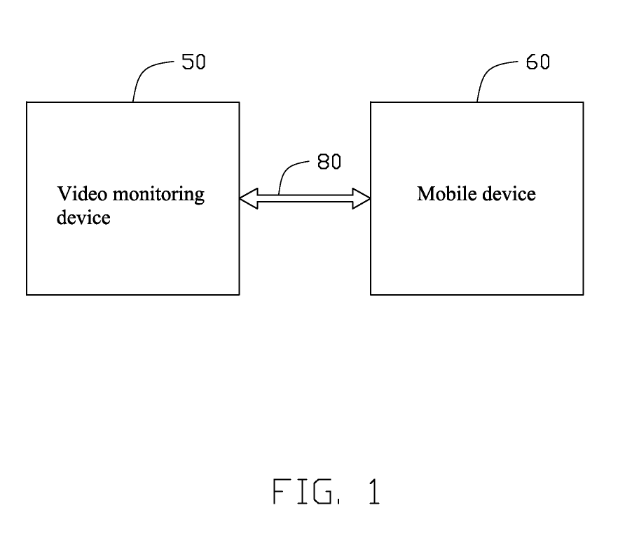

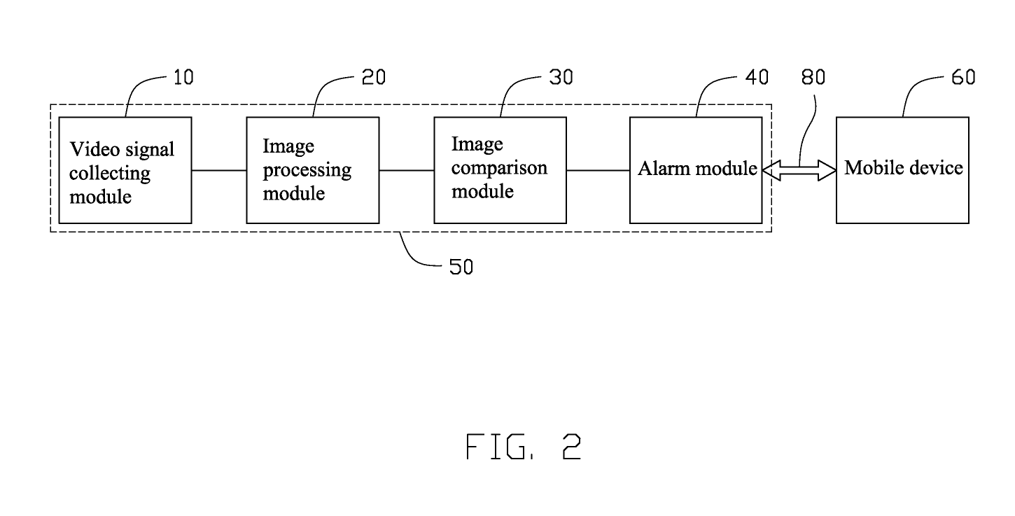

Referring to FIGS. 1 and 2, a system for autonomously monitoring a certain region by a video monitoring device 50. The video monitoring device 50 is capable of collecting video signals of the region to be monitored and transmitting the collected video signals to a mobile device 60. The video monitoring device 50 includes a video signal collecting module 10, an image processing module 20, an image comparison module 30, and an alarm module 40. The video signal collecting module 10 is capable of collecting video signals of the region to be monitored. The image processing module 20 is capable of analyzing a current image and a previous image by processing the current and previous images using median filtering, graying, segmentation, and erosion processes. The image comparison module 30 is capable of calculating a number of points of difference between the current image and the previous image by differential arithmetic. The image comparison module 30 stores a predetermined threshold value of different points and is capable of outputting an alarm signal when the number of different points exceeds the predetermined threshold value. The alarm module 40 is capable of indicating an alarm condition when it receives the alarm signal and transmitting the current image of the region to be monitored to the mobile device 60 via a wireless network 80. In this embodiment, the wireless network 80 is GSM network or CDMA network. The alarm module 40 includes an alarm indicator such as a buzzer or a light emitting diode (LED) to be activated when the alarm signal is received.

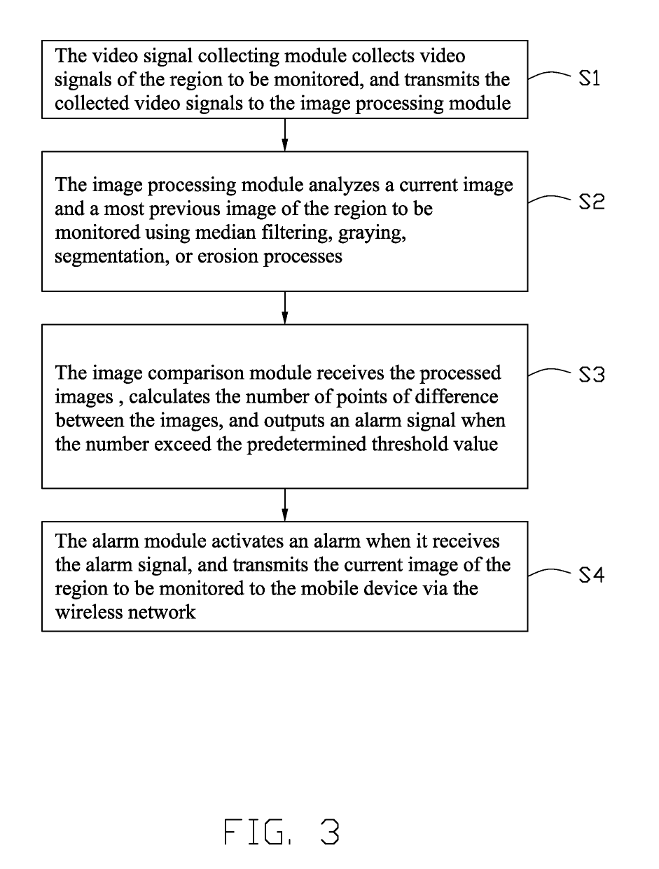

FIG. 3 is a flow chart illustrating a method for autonomous monitoring. Depending on the embodiment, certain steps described below may be removed, while others may be added, and the sequence of the steps may be altered. In one embodiment, the method for autonomous monitoring utilizing the above-described system includes the following steps:

S1: the video signal collecting module 10 collects video signals of the region to be monitored, and transmits the collected video signals to the image processing module 20;

S2: the image processing module 20 analyzes a current image and a most previous image of the region to be monitored using median filtering, graying, segmentation, or erosion processes;

S3: the image comparison module 30 receives the processed images, calculates the number of points of difference between the images, and outputs an alarm signal when the number exceed the predetermined threshold value;

S4: the alarm module 40 activates an alarm when it receives the alarm signal, and transmits the current image of the region to be monitored to the mobile device 60 via the wireless network 80.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

Depending on the embodiment, certain of the steps described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. A method for autonomous monitoring comprising:
collecting video signals of a region to be monitored by an video signal collecting module;
analyzing a current image and a previous image of the region to be monitored from the video signals by an image processing module;
calculating a number of points of difference between the current image and the previous image by an image comparison module; wherein the image comparison module stores a predetermined threshold value of different points and is capable of outputting an alarm signal when the number of different points exceeds the predetermined threshold value; and
indicating an alarm condition when receives the alarm signal by an alarm module.

2. The method of claim 1, further comprising transmitting the current image to a mobile device via a wireless network by the alarm module when receives the alarm signal.

3. The method of claim 1, further comprising processing the current image and the previous image using median filtering process.

4. The method of claim 1, further comprising processing the current image and the previous image using graying, segmentation, and erosion processes.

5. The method of claim 1, wherein the image comparison module is capable of calculating the number of points of difference between the current image and the previous image by differential arithmetic.

6. A system for autonomous monitoring, comprising:
an video signal collecting module capable of collecting video signals of a region to be monitored;
an image processing module capable of analyzing a current image and a previous image of the region to be monitored from the video signals;
an image comparison module capable of calculating a number of points of difference between the current image and the previous image; wherein the image comparison module stores a predetermined threshold value of different points and is capable of outputting an alarm signal when the number of different points exceeds the predetermined threshold value; and
an alarm module capable of indicating an alarm condition when it receives the alarm signal.

7. The system of claim 6, wherein the alarm module comprises an alarm indicator comprising of a buzzer or a light emitting diode to be activated when the alarm signal is received.

8. The system of claim 6, wherein the alarm module is capable of transmitting the current image of the region to be monitored to a mobile device via a wireless network when receives the alarm signal together with indicating the alarm condition.

9. The method of claim 8, wherein the wireless network is GSM network or CDMA network.
